(19) United States
(12) Patent Application Publication
(10) Pub. No.: US 2007/0271359 A1
(43) Pub. Date: Nov. 22, 2007

(54) Web-based interface for building management systems

(76) Inventors: John Davis, Brentwood, CA (US); Richard W. Umstattd, San Jose, CA (US); Bryan Frew, Antioch, CA (US)

Correspondence Address: MCGUIREWOODS, LLP, 1750 TYSONS BLVD, SUITE 1800, MCLEAN, VA, 22102, US

(21) Appl. No.: 11/802,424

(22) Filed: May 22, 2007

Related U.S. Application Data
(63) Continuation of application No. 10/174,798, filed on Jun. 18, 2002.

(51) Int. Cl. G06F 15/177

(52) U.S. Cl. 709/222

(57) ABSTRACT

A universal web-based interface is provided for remotely accessing any building management system capable of communicating with an external computer. During an initiation routine, the software providing the interface automatically determines what objects are connected to the building management system, and then creates data structures and web pages suitable for storing and displaying those objects. The software comprises a driver that provides a communication interface, and a communications protocol-independent generic portion.

### BACKGROUND OF THE INVENTION

1. Field of the Invention

The present invention relates generally to building automation, and more particularly to communication with automated building management systems over the World Wide Web.

2. Description of the Related Art

The field of building automation encompasses the control of building operations such as climate control, security, fire-detection, energy management, water management, and communications. In most large commercial and institutional buildings, building management systems control these operations. A single building management system may control all of the operations in a building, or a building may have a number of building management systems, each controlling one or more operations.

A building management system is typically a multi-tier control system. An exemplary building management system is shown in FIG. 1. At the highest tier of the building management system 10 is an intelligent controller which oversees the operation of the building management system 15. The intelligent controller may be, for example, an on-board computer, or a standard PC. The intelligent controller 15 may interface with a lower tier of control units 21, 22, 23. These control units may interface with a variety of measurement, sensing, control and actuating devices. In a multi-tier control system such as the one in FIG. 1, the intelligent controller 15 sends high-level commands such as set objects to the control units 21, 22, 23 while the control units 21, 22, 23 carry out the measurement and control functions required to reach those set objects. So, for example, the first control unit 21 may receive a temperature set object from the intelligent controller 15, and to reach that set object the controller monitors the temperature with a temperature measurement device 31 and modifies the temperature with the HVAC device 32. The second example control unit 22 in FIG. 1 controls lighting 35. This second control unit 22 would receive commands from the intelligent controller 15 such as to turn on the lighting during business hours, to turn off the lighting during non-business hours, or to turn on lighting in a portion of the building if someone is in that portion. To carry out these commands, the controller 22 could interface with a motion sensor 33, and a switch 34. Some control units, such as the third example control unit 23, may simply monitor a sensing device 36, and send an alarm to the computer 15 when the sensing device 36 is activated. So, for example, the sensing device 36 could be a fire-detecting device or a glass-breakage sensor, and the control unit 23 would send an alarm to the computer 15 if these devices detected a fire or a break-in respectively.

In the example building management system in FIG. 1, the intelligent controller 15 is only connected to devices 21, 22, 23. These devices could be controllers, measurement devices, sensors, or actuators. The intelligent controller in such a building management might directly control physical devices, or delegate control of physical devices to controllers. The intelligent controller 15 in a building management system could also be connected to one or more other intelligent controllers.

Devices connected to a building management system typically exchange information about themselves and with each other. This information includes a list of parameters associated with the device. A parameter can be a value measured by a device, a value input into a device, or a valve indicating or controlling the status of a device. Each parameter associated with a device is referred to as a “object”. For example, the objects associated with a thermostat might include a temperature reading, time values, and set objects. A object associated with a light switch might be the oil/off status of the switch. In general, a building management system interfaces with one or more devices, and the device reports one or more object valves to the building management system.

User-access to building management systems, such as the system 10 in FIG. 1, is accomplished by communicating with the intelligent controller 15 by means of one or more access devices such as a panel 40 or a computer 45. The access device or devices are typically located within the same building. Some buildings, like large commercial and institutional buildings, may have more than one building management system. For example, a large building may have separate building management systems for climate control and security.

It is common for an organization, such as a company or a school system, to have buildings in separate geographic locations. For example, a department store may have branches in several different towns, or a state university may have a number of different campuses. Organizations with geographically dispersed buildings often desire to control the operations of those buildings from a central location. Such central control is possible only if the building management systems in the dispersed buildings can be remotely accessed.

Available methods of remotely accessing building management systems have evolved with changes in computer and telecommunications technology. Accordingly, building management systems built before the widespread availability of the Internet are not capable of being accessed over the Internet. Even after use of the Internet became widespread, the building management system industry was slow to offer Internet-based remote access. As a result, there are a number of building management systems currently in use that are not inherently capable of being remotely accessed over the Internet. These building management systems are referred to as “legacy” systems. Examples of legacy building management systems that embodiments of the invention may interface with include the Andover AC256, the American Auto-Matrix SF1, and the CSI I/NET. Some manufacturers of building management systems offer add-on Internet interfaces for their own brand legacy systems. These add-on interfaces, as well as the built-in Internet interfaces offered in non-legacy building management systems, come in two varieties: those that only can be accessed through proprietary software, and those that can be accessed through a web interface program such as a browser.

There are a number of advantages to using a web-based interface instead of proprietary software to remotely access a building management system over the Internet. Web-based access provides the ability to communicate with the remote building management system through any computer that can access the web, including web appliances and some personal digital assistants. Since the World Wide Web encompasses computer networks beyond the Internet, a web-based access system also allows a building management system to be accessed through other networks such as LANs or WANs. Web-based access also enables an organization to use different computers to remotely access a building management system. When proprietary Internet access software is required, it is more difficult to use more than one computer for remote access because the proprietary software may not be available for multiple computer platforms, and because the proprietary software may require an additional license fee for each copy of the software. Web-based access also eliminates the need to maintain software on the client computer. Proprietary software may require upgrades in the software that require reloading the new software on each of the multiple computer platforms. Web-based access should also reduce training costs because of the widespread use of web-browsers and the relative ease of a web browser's object and click user interface. Although web-based interfaces are available for some specific legacy systems, there are many legacy systems in use for which no web-based interface is available.

Central control of a number of geographically dispersed building management systems becomes very complicated because different building management systems typically have different remote access protocols. For example, many legacy building management systems may only be remotely accessed through a serial port, and many of those systems manufacturers do not offer a web-based interface to those systems. Some non-legacy systems require proprietary remote-access software to be accessed over the Internet, while other non-legacy systems have web-based interfaces. The non-legacy systems requiring proprietary software may come from different manufacturers, and thus require different proprietary software. In short, it is generally not possible to remotely access multiple building management systems through a single computer, or through a single piece of software. There have been industry-wide efforts to develop standard communications protocols for remotely accessing building management systems, but as yet no industry standard exists. Even if such a standard were eventually developed, already existing building management systems, especially legacy systems, probably would not conform to that standard.

### SUMMARY OF THE INVENTION

It is an object of the invention to provide a common web-based interface for any building management system that is capable of communicating with an external computer regardless of what access protocol that system uses. The common web-based interface according to the present invention is provided by software executed on an interface computer connected to the building management system.

When the interface computer is first connected to the building management system, the software performs an initiation routine. In the first step in the initiation routine, the software employs a driver to establish communications between the interface computer and the building management system. The software then determines what objects are connected to the building management system, determines the characteristics of the objects, and creates a database tailored to store data relating to those objects.

After completing the initiation routine, the software provides a web-based interface to the building management system. To more efficiently provide this interface, the software is modular in nature. The modules are structured as multiple functional layers. A user interface layer performs tasks related to communicating over the World Wide Web. A server layer coordinates data transfer between the user interface layer and a database layer that manages a database containing data relating to the objects. Finally, a translation layer and a driver layer provide an interface between the other layers and the building management system. By providing the software this multi-layer structure, only the translation layer and the driver layer need be customized for a specific building management system.

### BRIEF DESCRIPTION OF THE DRAWINGS

These and other aspects of the invention will be readily apparent to the skilled artisan in view of the description below, the appended claims, and from the drawings, which are intended to illustrate and not to limit the invention, and wherein:

FIG. 1 shows one example of a building management system that may employ the web-based interface in accordance with the invention;

FIG. 2 shows an embodiment of a system for providing a web-based interface for a building management system;

FIGS. 3A and 3B combined show one embodiment of an initiation routine that may be employed by a web-based interface in accordance with the invention;

FIG. 4 shows the organization of one embodiment of a portion of the software that provides web-based remote access to a building management system in accordance with the invention;

FIG. 5 illustrates the roles the software components shown in FIG. 4 play in providing web-based remote access to a building management system in accordance with the invention;

FIGS. 6A, 6B, and 6C show example web pages displayed by a web-based interface in accordance with the invention; and

FIG. 7 shows how alarms output by a building management system are managed by a web-based interface in accordance with the invention.

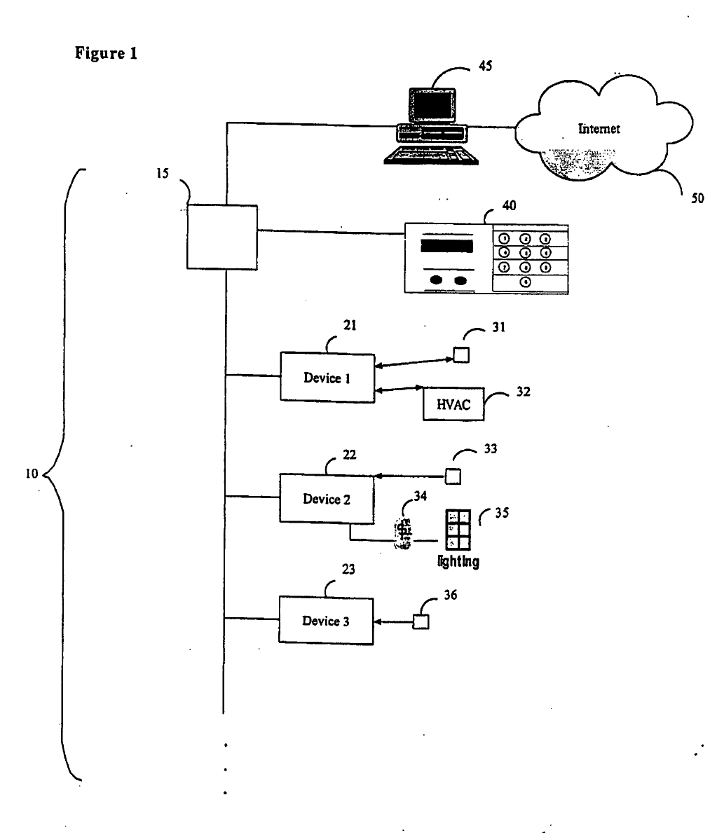

### DETAILED DESCRIPTION OF THE INVENTION

Embodiments of the invention provide an interface to the World Wide Web for legacy building management systems capable of interfacing with an external computer. Building management systems that can interface with an external computer have a communications port for establishing a connection to an external computer, and a protocol for communicating with the external computer. The communication protocol consists of the format of the commands sent to the building management system, and the format in which the building management system sends data to the external computer. Different building management manufacturers use their own proprietary communication protocols. Furthermore, a manufacturer may use different communication protocols for its various building management system models. Embodiments of the current invention are able to interface with different types of building management systems through different types of communications ports, to communicate with building management systems that use different communications protocols, and to present a common web-interface regardless of what communication port and communication protocol the building management system uses.

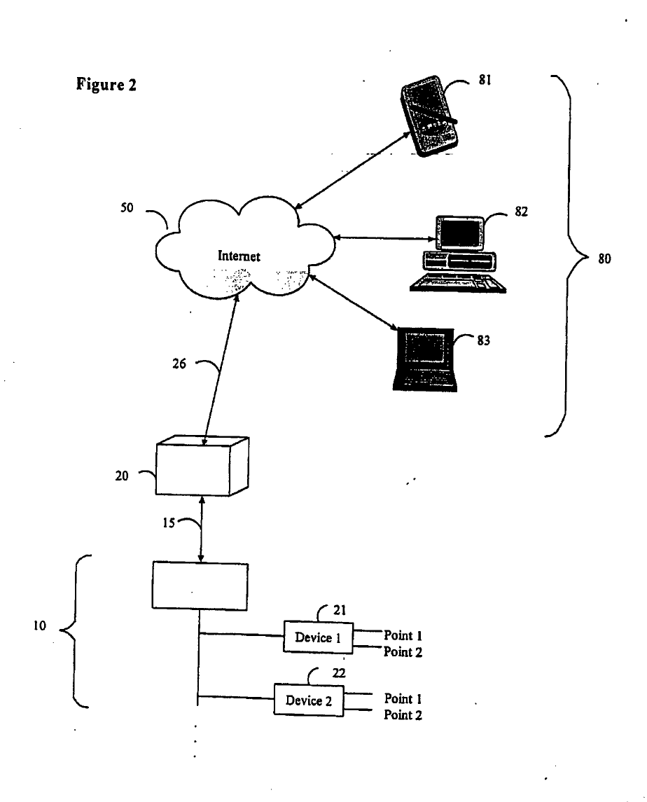

FIG. 2 shows an embodiment of a system for providing a web-based interface for a building management system capable of interfacing with an external computer. In the embodiment of FIG. 2, a building management system 10 is connected to an interface computer 20. Since the role of the interface computer 20 is to enable a remote computer to access the building management system 10, the interface computer 20 and the building management system 10 are typically located in the same building. Communications between the building management system 10 and the interface computer 20 take place over a connection 15. The connection 15 may be a serial (RS-232) connection, or a more advanced type of connection such as a USB or IEEE 1394. Since different building management systems may communicate with external computers through different types of connections, it is advantageous to provide the interface computer 20 with a number of different communications ports. When communications occur through a serial connection, it may be necessary to manually set the baud rate and handshaking parameters on the building management system. If a more advanced type of connection is used, it may not be necessary to manually set any communications parameters.

To provide a web interface to the building management system 10, the interface computer 20 must be connected to the Internet 50. In the embodiment of FIG. 2, the interface computer 20 is configured to be a standalone web server. The interface computer 20 may be connected to the web in any suitable manner. For example, the interface computer could be connected to an existing Ethernet network, where the router and hub of the existing Ethernet network direct communications between the interface computer 20 and the Internet 50. The interface computer 20 sends and receives information over the Internet by means of the standard TCP/IP protocol so it can generate web pages that are compatible with standard web interface programs such as browsers. Just like any standard web server, the interface computer 20 may be assigned a static IP address. By entering the static IP address into the web interface program on the interface computer 20, for example by entering the address into the address line of a web browser, a user may access the interface computer 20 from any computer 80 that can access the World Wide Web. The computer accessing the web could be a PDA 81, a desktop computer 82, or a laptop 83.

After the connection 15 is established between the interface computer 20 and the building management system 10, the interface computer 20 can communicate with the building management system using the communication protocol specific to that building management system. It is advantageous that the portion of the interface computer 20 software that consist of a separate module that is tailored to send and receive information according to the specific communication protocol for the particular building management system to which it is connected. The use of a separate module for communication with a particular building management system allows other modules of the interface computer software to be written in a generic form so that they may be used regardless of what type of building management system the interface computer 20 is connected to. Other advantages and detailed embodiments of executing modular software on the interface computer are discussed in more detail below.

The function of the interface computer 20 and its software is to provide a web-based interface that presents data relating to a building management system's objects to a user, and that allows the user to manipulate some of those objects. Before the interface computer 20 software can carry out this function, the identity of the building management system's objects must be available to the interface computer 20 software. A building management system in a large commercial building may monitor and control hundreds or thousands of objects. Having to manually enter the identity and properties of a large number of objects is not only error prone, but also very time consuming. Accordingly, it is desirable that the interface computer 20 be able to automatically determine the identity and properties of the objects monitored by the building management system so that manual input of the is not required. Software in accordance with embodiments of the current invention is able to identify the objects connected to a building management system, thus eliminating the need for manual entry of that information.

The interface computer software identifies the objects connected to the building management system to which it is connected by means of an initiation routine. In the first part of the initiation routine, the interface computer software identifies the appropriate port for communicating with the building management system. Next the software establishes communications through that port. After communications are established, the software determines what devices are controlled or monitored by the building management system. In the last part of the initiation routine, the software identifies the objects connected to each device. The user may activate the initiation routine by accessing the interface computer 20 through a web-interface program.

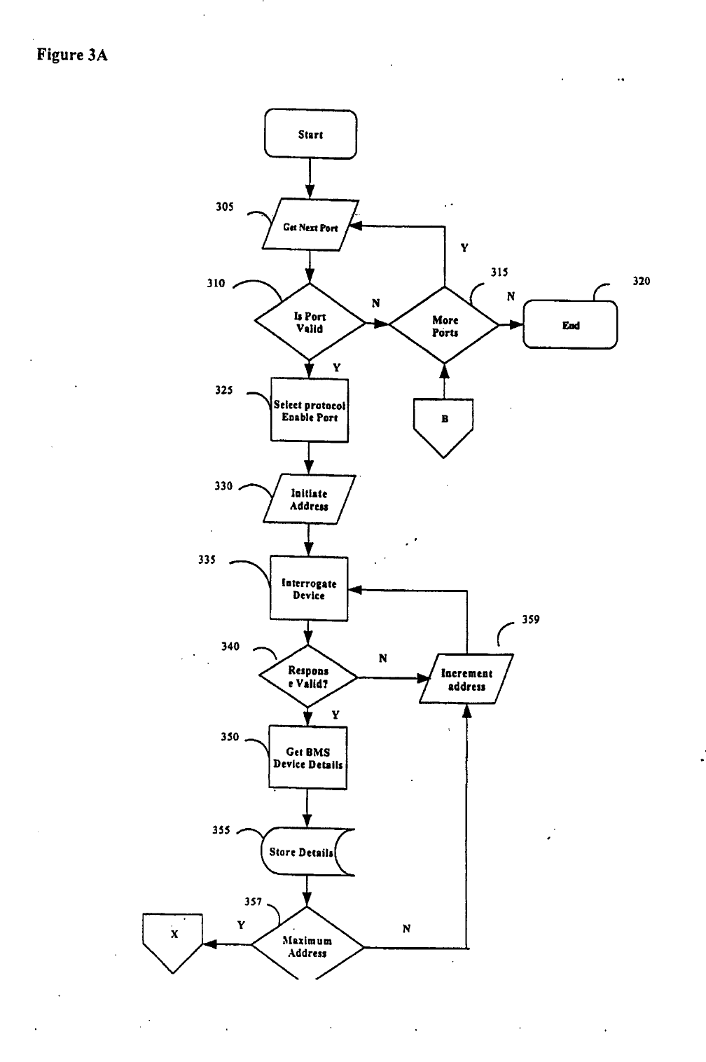

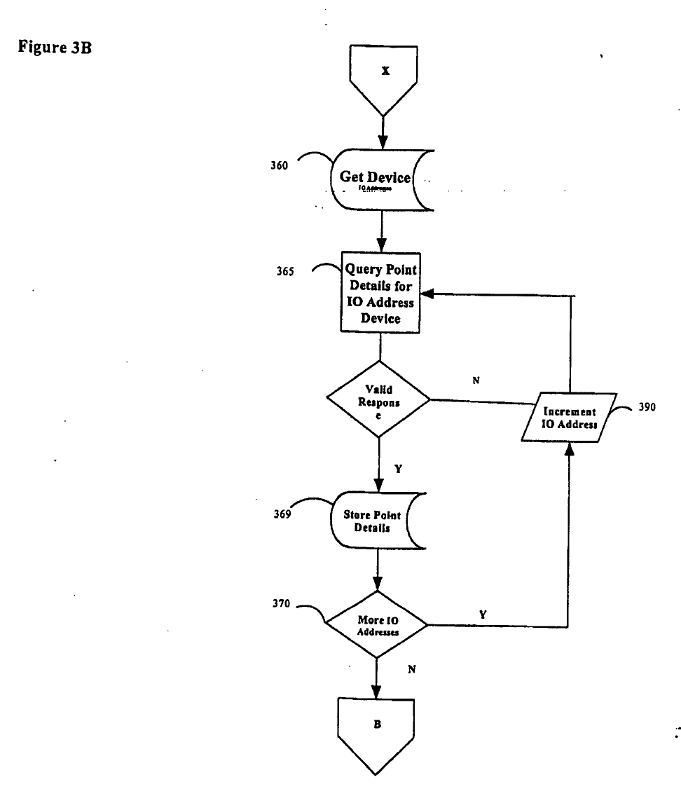

The details of one embodiment of an initiation routine are shown in FIGS. 3A and 3B. As discussed above, the interface computer 20 in FIG. 2 contains a number of different communications ports so that it may interface with different types of building management systems. Before communications with a particular building management system can be established, the software on the interface computer 20 in FIG. 2 must be configured so that the appropriate communication port is connected to the building management system. The identity of the appropriate ports may be entered manually as shown in FIGS. 3A and 3B, or the software running on the interface computer may determine which port is connected to a building management system by sequentially checking each port for the presence of a connection to building management system. The sequential checking process consists of steps 305, 310, and 315. If none of the ports are connected to a building management system, the software terminates at step 320. If the software determines that a port is connected to a building management system, or if the user indicates that a port is connected to a building management system, the software then establishes communications between the interface computer and the building management system by selecting 325 the appropriate protocol for communicating with the building management system and by enabling communications with the building management through the appropriate port.

As will be discussed in more detail below, the software running on the interface computer consists of modules that are structured as multiple functional layers. The task of selecting 325 the appropriate protocol consists of selecting the appropriate module of code for translating a generic command set into and out of the communications protocol recognized by the building management system. This module of code is called the translation layer. The task of enabling 325 the communications port consists of selecting the appropriate module of code for managing the communications between the interface computer and the building management system. This module of code is called the driver. One suitable method for selecting the appropriate translation layer and driver is to have the user manually enter the make and model of the building management system, and then having the interface computer software select the appropriate translation layer and driver for that particular make and model.

The interface computer software is designed so that the translation layer and the driver are the only software modules that are tailored for use with a specific building management system. This allows all other software modules, such as the modules that perform the initiation routine tasks listed in FIGS. 3A and 3B, to be generic modules that may be used for any building management system. Therefore only the translation layer and the driver need to be modified to allow the interface computer software to be used with different building management systems.

After communications are established 325 between the interface computer and building management system, the interface computer software determines what devices connected to the building management system. A building management system typically assigns each device connected to it an address. The exact nature of this address differs for different makes and model of building management systems. In the method of FIG. 3A, the interface computer software determines what devices are connected to a building management system by sequentially stepping in steps 330 through 359 through every possible addresses, and checking each of those addresses for the presence of a device. Starting 330, with the lowest address, the software determines whether a device is present at an address by sending 335 a device interrogation command to the address, and then determining 340 whether the command generates a valid response. If a valid response is obtained, indicating the presence of a device at that address, the software obtains 350 the relevant details about the device from the building management system. These details about a device may include an alphanumeric identifier for the device, information identifying what type of device it is (e.g. thermostat, HVAC device, etc.), alarm information, time schedule information, passwords, and whether any other devices are connected to it. During the operation of the device, these details could either be inputs to or outputs from the device. For example, the alarm information could be a alarm condition output by the device, and the time schedule for the device could be input into the device. The details about the device obtained 350 from the building management system and the address of the device are then stored 355 in a database. The interface steps through each possible address by incrementing 359 the address count until 357 all possible addresses have been interrogated.

After the interface computer software identifies the address of each device attached to the building management system, the software determines what objects are associated with each of those devices. The process of identifying objects associated with a device for the embodiment of FIGS. 3A and 3B consists of cycling through all of the input-output (IO) addresses available to the building management system. The first step in the cycling process is querying 360 the building management system to determine the range of available IO addresses. For each IO address, the interface computer software queries 365 the building management system for the details of the objet associated with the IO address. These details would typically include an alphanumeric designation for the object, and values input to and output from that object. Examples of values input to a object are the set object for a controller, the ON/OFF status of a switch, and the mode status (e.g. manual vs. automatic, test vs. run) of a device associated with that object. Examples of values output from a object are the temperature value output by a temperature measurement device, and the existence of an alarm condition. If 367 there is no valid object associated with the IO address, the software moves on 390 to the next IO address. If there is a valid object associated with the IO address, a record formatted to store the object details is created 369 in a database. The software steps through each IO address device by incrementing 390 the IO address count and repeating steps 365 and 369 until 370 all of the IO addresses have been queried.

Since embodiments of an interface computer in accordance with this invention may interface with more than one building management system, the initiation routine may check 315 the interface computer's other ports to determine whether other building management systems are connected to those ports. If another building management system is detected, the initiation routine repeats the above-described process for determining what devices are connected to the building management system and what objects are associated with those devices. Once all of the ports of the interface computer have been checked for the presence of a connection to a building management system, the initiation routine terminates 320.

During the initiation routine described in FIGS. 3A and 3B, the interface computer software stores device information 355 and object information 369 in a database. The device and object information includes characteristics of the device or object, data to be received from the device or object, and data to be sent to the device or object. The information is preferably stored in a relational database. For example, the database may be a standard relational database accessible through the Structured Query Language (SQL).

To facilitate the use of the interface computer with a variety of different building management systems, the database records in which device and object information are stored are preferably constructed from a predefined set of fields. Even though there are a variety of different legacy building management systems in use, those different systems control the same basic types of devices and process the same types of data. Accordingly, the various device data processed by those different systems can be categorized into a manageable number of predefined fields. So when the initiation routine obtains information about a device 350 or a object 365, the subsequent step of storing (355,369) that information consists of creating a database record for that device consisting of one or more predefined fields. Example of predefined fields are an integer field that could store the address assigned to a device by the building management system, a floating object numeric field that could store the value of a object, a binary field that could store the controllable ON/OFF status of a switch, and an alphanumeric field that could store the name designation assigned to a object by the building management system. Accordingly, to create a database record for a device or object, the interface computer software determines what information about the device or object was obtained in steps 350 or 365 respectively, and then creates a record constructed from predefined fields in a database using SQL commands. Predefining database fields, along with the use of a specific translation layer and driver for a specific building management system, allows a single generic database construction routine to be used for all different types of building management systems.

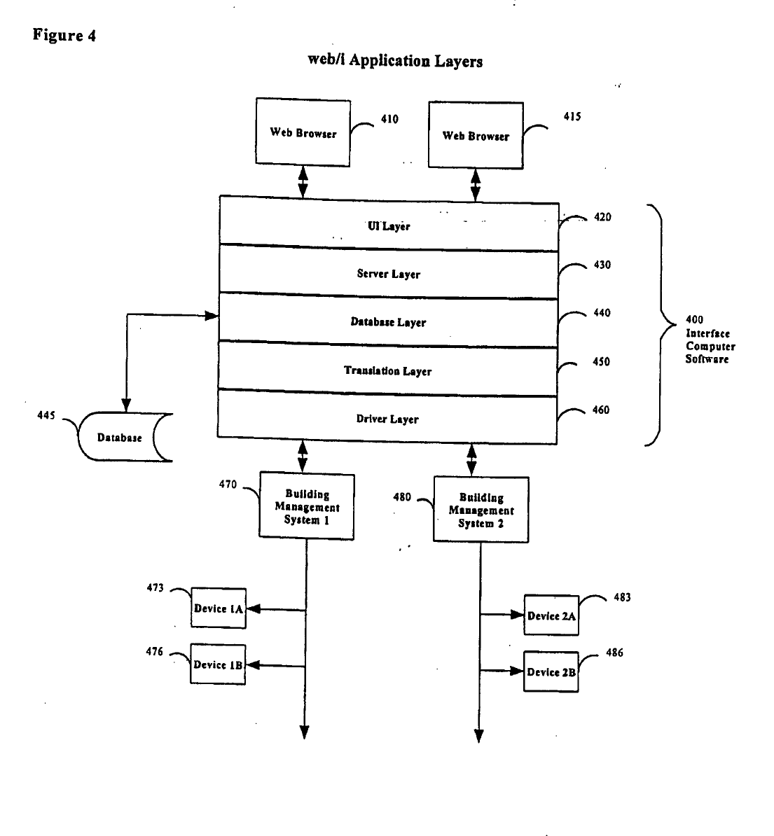

After the initiation routine is complete, the interface computer 20 in FIG. 2 is configured to provide web-based remote access to the building management system 10. One embodiment of the portion of the interface computer software that provides that remote access is shown in FIG. 4. The interface computer software is configured so that separate modules of code correspond to different layers of communication between the user and each building management system in communication with the interface computer. Accordingly, the different modules are referred to as layers. The user-interface (UI) layer 420 manages the web-based communications with the user. The server layer 430 translates user commands to a generic command language that communicates with the database layer 440. The command language used by the server layer 430 is generic in that it can be used for any building management system. The database layer 440 stores and retrieves data to and from the database 445. These data are communicated to or from either the server layer 430 or the translation layer 450. The translation layer 450 translates data and generic commands from the database layer 440 and the server layer 430 into the particular communications protocol understood by the building management system. Finally, the driver layer 460 manages the communications between the building management system and the interface computer.

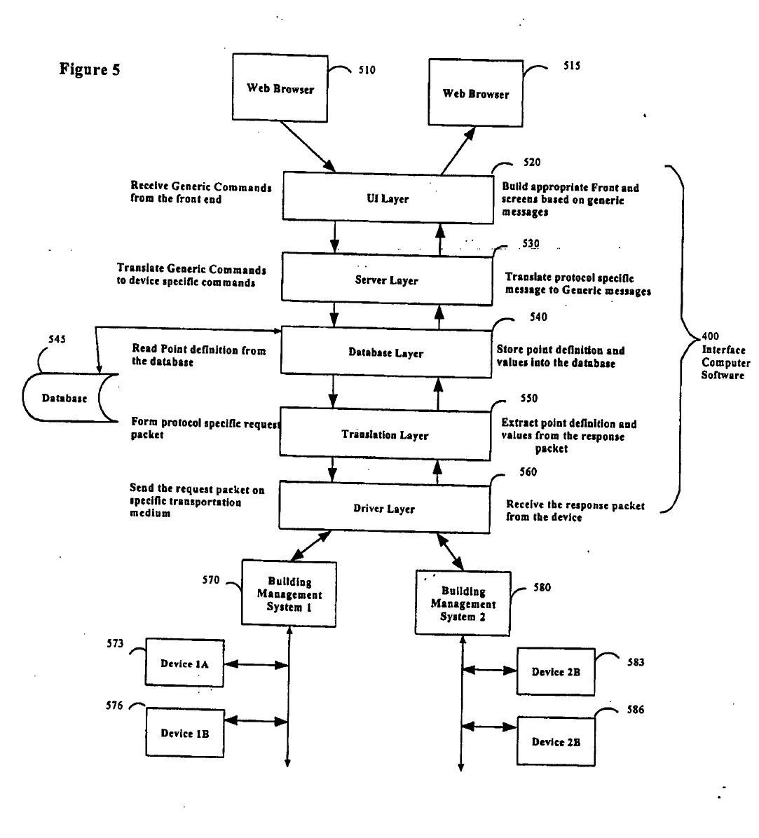

The operation of each of the layers is best understood by examining an exemplary set of communications. FIG. 5 illustrates the role the various layers play in enabling communication between the web-based interface presented to the user and the building management system. In the embodiment shown in FIG. 5, data are being transferred between two building management systems (each of which corresponds to item 10 in FIG. 2) and an interface computer (20 in FIG. 2) over a communications link (26 in FIG. 2). The right side of FIG. 5 illustrates how the modular interface computer software transfers object data from the devices 573,576,583,586 attached to the building management systems 570,580 to a web-browser 515. The driver layer 560 of the interface computer software 400 constructs commands that the particular building management system 580 can understand and respond to. Low-level management of those communications involves controlling the data flow between the building management system and the interface computer. So, for example, if the connection between the interface computer and the building management system 580 were an RS-232 connection, the driver layer 560 constructs commands that the particular building management system can understand and respond to.

When the interface computer software 400 receives a data packet from one of the building management systems 570,580, that data packet is formatted in the communications protocol specific to the particular building management system (570 or 580). The translation layer 550 parses the data packet and extracts the object identities and object values. These extracted object identities and values are then relayed to either the database layer 540 or the server layer 530.

The database layer 540 places some or all of the object data received from the translation layer 550 into the appropriate database records. The database records were created during the initiation routine described above. The database layer 540 places the object data into the appropriate record by correlating the object identity received from the translation layer 550, which is the alphanumeric designation assigned the object by the building management system (570 or 580), with the alphanumeric designations stored in the database. The data leaving the translation layer 550 does not necessarily have to be stored in the database 545 by the database layer 540. Instead, the data may be passed directly from the translation layer 550 to the server layer 530, without being stored in the database 545 by the database layer 540.

The object data leaving the translation layer 550, or leaving the database layer 540 if the data were stored in the database 545, are then sent to the server layer 530. The server layer 530 takes data from either the translation layer 550 or the database layer 540 and transforms the data into information suitable to be displayed to an end user. For example, the data might contain the text description of the object, and a floating-object number containing the value of the object. The server layer 530 would transform the text description, which might be an unintelligible alphanumeric designation assigned to a object by the building management system, into a meaningful description such as “Office Temperature”. The server layer 530 might round the floating-object number to a reasonable number of decimal places, or convert a binary value such as 0 or 1 to a message such as “OFF” on “ON”. After the server layer has translated object data into information that can be displayed to the end user, that information is relayed to the UI layer 520.

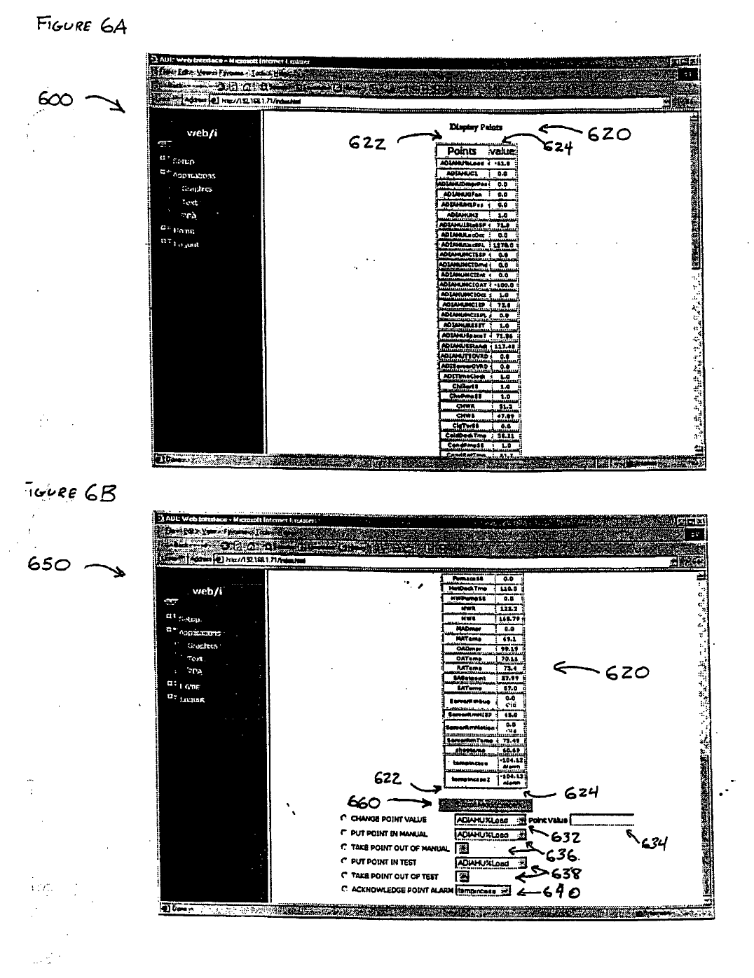

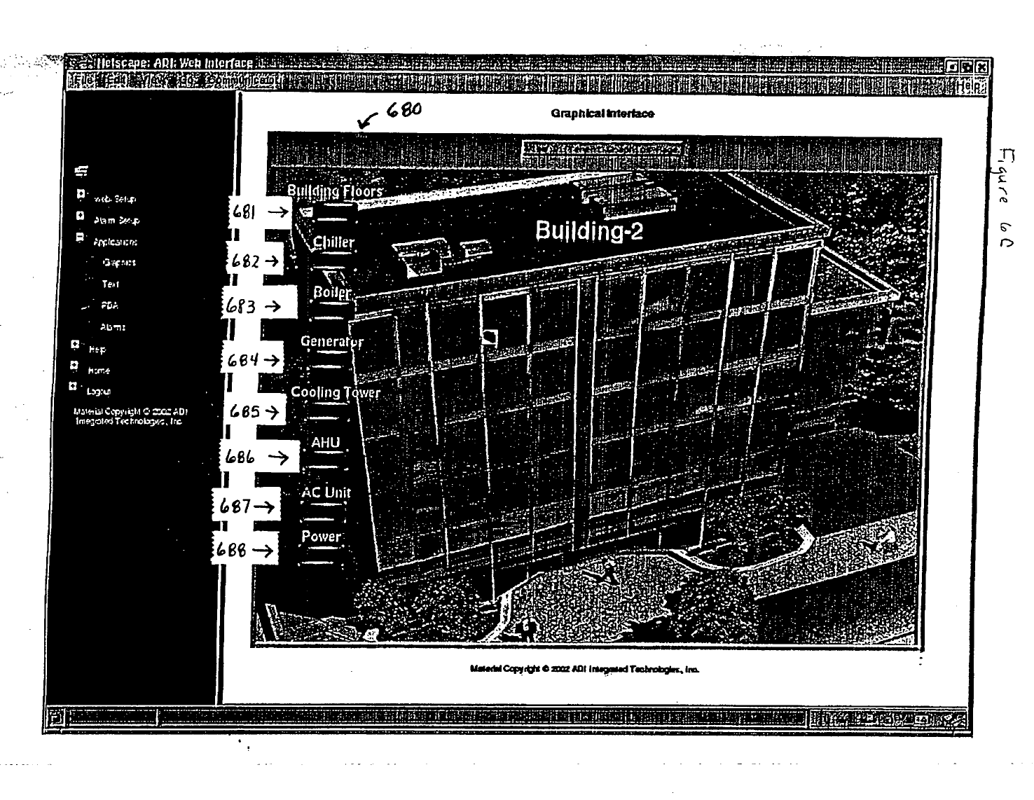

The UI layer 520 controls the layout and presentation of the web pages viewed by a user with a web browser 515. It is advantageous to have the UI layer dynamically compose web pages using an appropriate servlet. The servlet would take the data from the server layer 530 and compose a web page containing those data. The servlet could, for example, compose an HTML page that presents data from a number of objects in a tabular format. This type of presentation would facilitate the viewing of the pages on devices that have limited graphics capability, such as PDA's. An example web page containing the tabular presentation of object data collected from a CSI I/NET system is shown in FIG. 6A. The table 620 that contains the object data on the web page 600 consists of a first column 622 that contains the alphanumeric designation assigned the object by the building management system, and a second column 624 that contains the value of the object, rounded to one decimal place. The UI layer 520 in FIG. 5 could also have applets that produce image maps based on a user-defined template. In other words, during an initiation routine the user could design image templates, and then an applet in the UI layer 520 would construct a graphical representation based on the appropriate template. User-designed image templates would allow the user to present data in formats other than tables.

It may be desirable to incorporate a user authentication capability into the UI layer 520. Servlets or applets may be used to provide the desired user authentication functionality. User authentication may be used to control which objects values users are able to view, and to control which object values users are able to modify. User authentication could also be used to control which users are allowed to configure and initialize the software, and which users receive alarm notifications.

The left side of FIG. 5 illustrates how the modular interface computer software transfers information from a web-browser 510 to a building management system 570,580.

The web-page requesting user input is generated by a servlet in the UI layer 520. The web page for receiving user input may be the same web page 600 used to display object values to the user. So, for example, the web page 650 shown FIG. 6B, which is able to accept user input, could be the bottom part of the web page 600 shown in FIG. 6A. This bottom part 650 contains input fields 632,634,636,638,640 in which the user may enter new object values.

In the exemplary web page in FIG. 6B, the user may choose which object to modify using the pull down box 632. The list of objects in pull down box 632 may be generated by querying the database (545 in FIG. 5) for a list of the objects found during the initiation routine. The pull down box 632 could list some or all of the objects in the database. After the user selects which object to modify, object attributes such as the object value, whether the object is manually or automatically controlled, whether the object is in test or active mode, or whether to acknowledge an alarm condition generated by the object may be modified by making appropriate entries in fields 634, 636, 638, and 640 respectively. After the user inputs these new object values, the user transmits the new values to the interface computer software (400 in FIG. 5) by depressing the Submit Modification button 660.

As an alternative to the text-based web pages shown in FIGS. 6A and 6B, a web page based in an image template is shown in FIG. 6C. The web page 680 is a graphical representation based on a user-defined image template. This type of web page 680 allows users to enter commands through a graphical user interface. So, for example, a user could select which building management system object to view or modify by clicking on one of the virtual buttons 681 through 688. The use of a graphical user interface can help reduce training costs and operator error by simplifying the user interface to the building management system.

Referring back to the left half of FIG. 5, when the web page containing the user's input is transmitted from the web browser 510 to the interface computer software 400, the UI layer 520 portion of the interface computer software 400 extracts the user's input from the web page. The user's input is then transmitted to the server layer 530, which correlates the input to the corresponding object values. Correlating the user's input to object values might involve substituting the name of the object shown to the user (e.g. “Office Temperature”) with the alphanumeric designation assigned to the object by the building management system (570 or 580), and correlating the other user inputs for that object to the corresponding object inputs.

After the server layer 530 determines which objects are to be modified according to the user's input, the new object values may be placed into the database 545 by the database layer 540. The database layer 540 would then flag the stored object values to be picked up by the translation layer 550. In an alternative embodiment, the new object value could be transmitted directly from the server layer 530 to the translation layer 550, bypassing the step of storing the new object value in the database 545. In either embodiment, the translation layer 550 takes the new object value and generates the commands in the communications protocol used by the building management system (570 or 580) that direct the building management system (570 or 580) to modify that object. The commands are then transmitted to the appropriate building management system (570 or 580) by the driver layer 560.

Dividing the code into separate modules or layers, as shown in FIG. 4, minimizes the amount of code that must be tailored to a particular type of building management system. Decoupling the tasks of communicating with the building management system from the tasks performed by the database 440, server 430 and UI 420 layers allows the code for those three layers to be used when interfacing to any type of building management system (470 or 480). Only code for the translation 450 and driver 460 layers need be modified for the communications protocol used by a particular building management system.

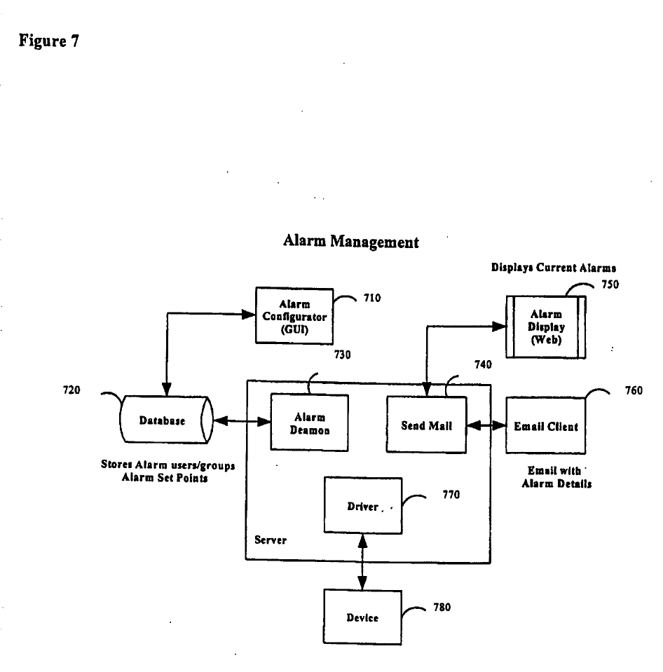

In addition to managing communications between the UI layer 420 and other layers, the server layer 430 also performs other tasks such as scheduling tasks to be performed by the interface computer software 400 and managing alarms received from building management systems 470 and 480. A process by which the server layer 430 may manage alarms is shown in FIG. 7. In the embodiment of FIG. 7, an alarm may emanate from a device 780 connected to a building management system (not shown), or from the software running on the interface computer 700. When a device connected to a building management system generates an alarm, the building management system would forward the alarm to the interface computer 700. Then, as discussed with regards to FIGS. 4 and 5 above, a driver layer 770 (460 in FIG. 4) of the interface computer software (400 in FIG. 4) running on the interface computer 700 processes the alarm communication from the building management system. When the alarm notification received by the driver is transmitted to the server layer (not shown), in the manner described in FIG. 5, an alarm module 730 in the server layer is activated. Alternatively, an alarm may emanate from the interface computer software if the alarm module 730 is programmed to monitor designated object values and to compare those values to preset alarm limits. Those preset alarm limits would be stored in a database 720. The values of those alarm limits could be entered into the database by means of alarm configurator software 710 running on the interface computer 700. A user could run the alarm configurator software 710 by accessing the interface computer 700 over the World Wide Web.

Regardless of whether the alarm is generated by a device or by the alarm module 730, the alarm module 730 is designed to inform certain users or groups of users of the existence of the alarm condition. The identities of those users or groups of users are stored in the database 720. Those identities could be entered into the database by means of alarm configurator software 710 running on the interface computer 700. A user could run the alarm configurator software 710 by accessing the interface computer 700 over the World Wide Web. After the alarm module 730 determines who should be informed of the alarm condition, a mail generating routine 740 sends an e-mail containing information about the alarm to an e-mail client. The transmission of the e-mail uses an Internet compatible e-mail protocol (SMTP), so the user could conceivably receive that e-mail on any device that can receive Internet e-mail. Accordingly, a user could conceivably receive the e-mail on a device such as pager, a PDA, a PC, or a cell phone. In addition to sending e-mail notification to the designated recipients, the mail generating routine 740 will inform any users accessing the interface computer software through the World Wide Web of the existence of an alarm condition.

The embodiments of interface computer and interface computer software described above are capable of providing a web-based interface for a building management system, regardless of what communications protocol the building management system uses. Although the present invention has been illustrated using specific embodiments, the invention is not meant to be so limited. It is intended that the present invention be defined solely by the appended claims.

What is claimed is:

1. A method by which software executing on an interface computer provides a web-based interface for a building management system connected to a plurality of objects, wherein the building management system is capable of communicating with an external computer using a communications protocol, the method comprising the steps of:
selecting a communications driver based on the communications protocol employed by the building management system;
employing the selected driver to establish communications between the interface computer and the building management system, and
determining what objects are connected to the building management system.

2. The method of claim 1, wherein the step of selecting a communications driver comprises receiving user input identifying the building management system and selecting the appropriate driver for that building management system.

3. The method of claim 1, wherein the step of selecting a communications driver comprises determining the identity of the building management system and selecting the appropriate driver for that building management system.

4. The method of claim 1, wherein the driver comprises a translation layer and a driver layer.

5. The method of claim 1, wherein the step of determining what objects are connected to a building management system comprises the steps of interrogating the building management system to determine what devices are connected to the building management system and interrogating the building management system to determine what objects are connected to the building management system.

6. The method of claim 1, further comprising the step of creating a database to store data relating to the objects connected to the building management system.

7. The method of claim 1, wherein the interface computer is connected to more than one building management system, and wherein the software executing on the interface computer is providing a web-based interface for those building management systems.

8. An interface computer that provides an web-based interface for a building management system, wherein the building management system is capable of communicating with an external computer using a communications protocol, the interface computer comprising a data storage device containing executable code that performs the following steps:
selecting a communications driver based on the communications protocol employed by the building management system;
employing the selected driver to establish communications between the interface computer and the building management system, and
determining what objects are connected to the building management system.

9. The interface computer of claim 8, wherein the step of selecting a communications driver comprises receiving user input identifying the building management system and selecting the appropriate driver for that building management system.

10. The interface computer of claim 8, wherein the step of selecting a communications driver comprises determining the identity of the building management system and selecting the appropriate driver for that building management system.

11. The interface computer of claim 8, wherein the driver comprises a translation layer and a driver layer.

12. The interface computer of claim 8, wherein the step of determining what objects are connected to a building management system comprises the steps of interrogating the building management system to determine what devices are connected to the building management system and interrogating the building management system to determine what objects are connected to the building management system.

13. The interface computer of claim 8, wherein the steps performed by the executable code also comprise the step of creating a database to store data relating to the objects connected to the building management system.

14. The interface computer of claim 8, wherein the interface computer is connected to more than one building management system, and wherein the executable code provides a web-based interface for all of those building management systems.

15. A system for communicating with a building management system over the World Wide Web comprising:
an interface computer in communication with both the building management system and the Internet;
wherein the interface computer executes software comprising a generic portion and a portion tailored to the building management system, wherein the operation of the generic portion is independent of the communications protocol employed by the building management system, and the portion tailored to the building management system provides an interface between the generic layer and the building management system.

16. The system for communicating with a building management system of claim 15, wherein the generic portion of the software comprises a user-interface layer, a server layer, and a database layer.

17. The system for communicating with a building management system of claim 15, wherein the portion of the software tailored to the building management system comprises a translation layer and a driver layer.

18. The system for communicating with a building management system of claim 16, wherein the user interface layer dynamically generates web pages by means of a servlet or applet.

19. The system for communicating with a building management system of claim 15, wherein the generic portion of the software is capable of sending e-mail notifications of alarm conditions.

20. The system for communicating with a building management system of claim 15, wherein the interface computer is connected to more than one building management system, and wherein the software executing on the interface computer provides a web-based interface for all of those building management systems.
